(19) United States
(12) Patent Application Publication
(10) Pub. No.: US 2010/0195456 A1
(43) Pub. Date: Aug. 5, 2010

(54) OPTICAL DISC CONTROL DEVICE

(76) Inventor: Mayumi Yasukouchi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/377,101

(22) PCT Filed: Aug. 10, 2007
(86) PCT No.: PCT/JP2007/065695

§ 371 Date: Feb. 10, 2009

(30) Foreign Application Priority Data
Aug. 10, 2006 (JP) 2006-219038

(51) Int. Cl. G11B 7/00

(52) U.S. Cl. 369/44.32; G9B/7

(57) ABSTRACT

There is provided an optical disc control device which can perform stable repetitive control without deteriorating the followability of a target value when performing jumping, retry, and long seek. The optical disc control device comprises an adder which receives a compensation target signal having a periodic frequency component, which is read out from an optical disc; a filter which outputs a signal component included in an arbitrarily determined learning frequency band in the output signal of the adder; a memory which successively updates and stores the output signal of the filter; a gain element which multiplies signal information outputted from the memory by a gain which is not less than 0 and not larger than 1, and inputs the product to the adder; a rotation speed detector which detects the rotation speed of the optical disc; a disc position detector which detects the position of the pickup on the optical disc; a circumferential direction move amount calculator which calculates the move amount of the pickup in the circumferential direction on the optical disc; and a memory controller which control the addresses for reading out the signal information stored in the memory on the basis of the circumferential direction move amount which is calculated by the circumferential direction move amount calculator.

### TECHNICAL FIELD

The present invention relates to an optical disc control device using a repetitive control circuit.

### BACKGROUND ART

In recent years, with progress in speed-up and high-densification of an optical disc, accuracy improvement in optical servo for maintaining a focal point of a laser beam on an information recording track of the disc in an optical disc device has been rapidly demanded. As a means for improving the accuracy of optical servo, repetitive control (learning control) has attracted attention. The repetitive control stores a one-period previous deviation signal in a memory, and controls a system according to the stored signal.

When performing such repetitive control, however, since the one-period previous signal is stored in the memory, if a non-periodic signal due to disturbance such as scratch on the disc or vibration applied to the device is undesirably given as an input signal, unnecessary noise might be mixed into the control system by learning this signal. Accordingly, there have conventionally been demanded a control system which can perform stable control even when such disturbance is applied, and a repetitive control method which can eliminate the influence of the unnecessary non-periodic component that might be undesirably learned by the memory.

Further, a control system generally has a plurality of control modes. Therefore, in a control system to which a conventional repetitive compensator is applied, since the contents in a memory in the repetitive compensator are lost every time the control mode is switched, the effect of the repetitive compensator cannot be seen until the repetition compensator is restored to its normal state when the operation mode returns to the original mode.

To be specific, when the repetitive compensator is applied to a tracking control system of an optical disc device, the effect of the repetitive compensator cannot be seen until a control error signal corresponding to one disc rotation is stored in the memory in the repetitive compensator every time the control mode is switched to the tracking control mode immediately after the seek operation. Accordingly, when information is written or read immediately after the seek, there is no effect of using the repetitive compensator, resulting in an increase in the tracking control deviation.

As a means to solve the above-mentioned problem, Patent Document 1 discloses a cyclic memory in which an input signal to a learning memory including a positive-feedback loop which is provided for repeatedly storing an input signal for one period is composed of a signal obtained by multiplying a present signal by a gain element k (0≦k≦1) and a signal obtained by multiplying an one-period previous output of the learning memory 104 by a gain element 1-k, and the repetitive control system continues learning with the k value being approximately 1 during the operation of the tracking control means while the repetitive control system is operated to perform no learning with the k being approximately 0 when the tracking control system is not operated, and further, the repetitive compensator continues learning with the value which is learned during the tracking control before starting the seek operation being an initial value immediately after the seek operation is completed and the tracking operation is restarted.

FIG. 7 is a diagram illustrating the configuration of a cyclic memory 700 in the conventional optical disc device which is disclosed in Patent Document 1. In FIG. 7, reference numeral 101 denotes a first adder for adding an output of the cyclic memory to a compensation target signal S1 having a periodic component such as an error signal in the control system of the optical disc device, which signal is a target to be followed. Reference numeral 102 denotes an attenuation gain β for varying the degree of learning. Reference numeral 103 denotes a low-pass filter, numeral 104 denotes a memory for storing frequency components for one rotation period of the disc, and numerals 105 and 106 denote gain elements for switching the signals to be stored in the memory 104. Reference numeral 107 denotes a second adder, and an output of this second adder 107 is stored in the learning memory 104. Reference numeral 108 denotes a tracking control mode on/off means.

The cyclic memory 700 having the above-described configuration is operated with the k value of the gain elements 105 and 106 being k=1 during the tracking operation. Further, the cyclic memory does not perform unnecessary learning by setting the k value of the gain elements 105 and 106 to 0 before starting the tracking operation or during the seek operation.

After the seek operation is completed, the cyclic memory 700 is operated with the k value of the gain elements 105 and 106 being k=1. At this time, since the periodic component of the input control signal before start of the seek operation is stored in the memory 104, a signal which compensates the periodic component of this control signal is immediately outputted from the cyclic memory 700, and consequently, the followability is enhanced immediately after starting the tracking operation.

By adopting the above-described configuration, the cyclic memory 700 can be operated from the moment the tracking operation is restarted immediately after completion of the seek operation, and thereby the followability is enhanced without attenuating the degree of learning. In the optical disc device having such repetitive control (learning control) system, since the followability to the periodic target can be enhanced without increasing the control band relative to the focus/tracking control comprising direct feedback control, it is possible to deal with a system having a narrow track, a system having a large eccentricity, and a system having a high disc rotation speed, i.e., a system having a high transfer rate.

Patent Document 1: Japanese Published Patent Application No. Hei. 9-50303

### DISCLOSURE OF THE INVENTION

### Problems to be Solved by the Invention

In the above-described conventional cyclic memory, however, when performing random access or long seek operation which are the characteristics of the optical disc device or when varying the disc rotation speed, a large difference occurs between the signal of just-previous one period which is stored in the memory and the compensation target signal which is just being detected from the optical pickup, and thereby the deviation cannot be sufficiently reduced. Accordingly, the optical disc device having the conventional cyclic memory has a problem that the focus control and tracking control of the optical, head cannot be stably performed when the above-described operation is carried out.

The present invention is made to solve the above-described problem and has for its object to provide an optical disc control device which can perform stable repetitive control which does not deteriorate the followability to a target value when performing jumping operation, retry, or long seek.

### Measures to Solve the Problems

In order to solve the above-described problems, there is provided an optical disc control device which performs a learning control for compensating a compensation target signal having a periodic frequency component corresponding to one rotation of an optical disc by using signal information of one period of the optical disc, and performs a servo control of a laser beam by using the compensated signal, comprising: an adder which receives the compensation target signal having a periodic frequency component, which is read out from the optical disc; a filter which outputs a signal component included in a predetermined learning frequency band in the output signal of the adder; a memory which successively updates the output signal of the filter, and stores the signal information of one period of the optical disc into addresses of one cycle; a gain element which multiplies the signal information outputted from the memory by a gain which is not less than 0 and not larger than 1, and inputs the product to the adder; a rotation speed detector which detects the rotation speed of the optical disc; a disc position detector which detects the position of the pickup on the optical disc, and outputs the detection result as disc position information; a circumferential direction move amount calculator which calculates the move amount of the pickup in the circumferential direction on the optical disc on the basis of the rotation speed of the optical disc which is outputted from the rotation speed detector, and the disc position information which is outputted from the disc position detector; and a memory controller which control the addresses for reading out the signal information stored in the memory on the basis of the circumferential direction move amount which is calculated by the circumferential direction move amount calculator.

According to Claim 2 of the present invention, the optical disc control device defined in Claim 1 includes an arithmetic unit which converts the signal period of the signal information stored in the memory on the basis of the rotation speed of the optical disc which is detected by the rotation speed detector; a radial direction move amount calculator which calculates the move amount of the pickup in the radial direction on the optical disc on the basis of the disc position information which is outputted from the disc position detector; and a switch which switches an input to the gain element between the output of the arithmetic unit and the output of the memory on the basis of a comparison result obtained by comparing the move amount of the pickup in the radial direction which is calculated by the radial direction move amount calculator with a predetermined threshold value.

According to Claim 3 of the present invention, the optical disc control device defined in Claim 1 includes a radial direction move amount calculator which calculates the move amount of the pickup in the radial direction on the optical disc on the basis of the disc position information which is outputted from the disc position detector, wherein the value of the gain used for the multiplication by the gain element is varied based on the move amount of the pickup in the radial direction which is calculated by the radial direction move amount calculator.

According to Claim 4 of the present invention, the optical disc control device defined in Claim 1 includes a zone memory which, with the disc being divided into plural zones, comprises plural memories each for storing the signal information of one period in each of the divided zones; a switch which switches an input to the gain element between the output of the zone memory and the output of the memory; and the memory controller selecting a memory from which data are to be read out among the plural memories configuring the zone memory, on the basis of the disc position information outputted from the disc position detector, controlling the address for reading out the signal information stored in the selected memory on the basis of the circumferential direction move amount calculated by the circumferential direction move amount calculator, and controlling the output of the switch on the basis of the circumferential direction move amount which is calculated by the circumferential direction move amount calculator and the disc position information which is outputted from the disc position detector.

According to Claim 5 of the present invention, the optical disc control device defined in Claim 1 includes a completion estimation unit which estimates the movement completed state of the pickup from a predetermined signal which indicates a change in the signal period of the compensation target signal; and the disc position detector detecting the position of the pickup on the optical disc on the basis of the result of the pickup movement completion estimation which is outputted from the completion estimation unit.

According to Claim 6 of the present invention, the optical disc control device defined in Claim 3 includes a zone memory which, with the disc being divided into plural zones, comprises plural memories each for storing the signal information of one period in each of the divided zones; a switch which switches an input to the gain element between the output of the zone memory and the output of the memory; and the memory controller selecting a memory from which data are to be read out among the plural memories configuring the zone memory, on the basis of the disc position information outputted from the disc position detector, controlling the address for reading out the signal information stored in the selected memory on the basis of the circumferential direction move amount calculated by the circumferential direction move amount calculator, and controlling the output of the switch on the basis of the circumferential direction move amount which is calculated by the circumferential direction move amount calculator and the disc position information which is outputted from the disc position detector.

According to Claim 7 of the present invention, the optical disc control device defined in Claim 3 includes a completion estimation unit which estimates the movement completed state of the pickup from a signal which indicates a change in the signal period of the compensation target signal; and the disc position detector detecting the position of the pickup on the optical disc on the basis of the result of the pickup movement completion estimation which is outputted from the completion estimation unit.

According to Claim 8 of the present invention, the optical disc control device defined in Claim 4 includes a completion estimation unit which estimates the movement completed state of the pickup from a signal which indicates a change in the signal period of the compensation target signal; and the disc position detector detecting the position of the pickup on the optical disc on the basis of the result of the pickup movement completion estimation which is outputted from the completion estimation unit.

### EFFECTS OF THE INVENTION

According to the optical disc control device defined in Claim 1 of the present invention, when performing jumping, retry, or seek, the move amount of the pickup in the circumferential direction is calculated using the disc position detector and the rotation speed detector, and the memory output is controlled to be changed from the memory position before start of pickup movement to the memory position at the movement end point, whereby the compensation target signal having the periodic component which is stored before start of the pickup movement is outputted from the moment immediately after the movement. Therefore, a difference between the signal of one period which is stored in the memory when jumping, retry, and seek is performed and the compensation target signal detected after the movement can be reduced, and thereby focus control and tracking control can be stably carried out immediately after the pull-in.

Further, according to the optical disc control device defined in Claim 2 of the present invention, when performing jumping, retry, or seek, the signal period of the compensation target signal stored in the memory is converted based on a difference in the rotation speed of the optical disc before and after the movement of the pickup, which rotation speed is detected by the rotation speed detector. Therefore, it is possible to correct a difference in periods of the control signals which occurs when the movement distance is long such as when performing long seek, and thereby focus control and tracking control can be stably performed immediately after pull-in. Further, the move amount in the radial direction of the disc is calculated from the disc position information detected by the disc position detector, and either of the output from the memory or the output from the arithmetic unit, whose period component is corrected, is selected as a feedback signal on the basis of the move amount and the predetermined threshold value. Therefore, the correlation between the compensation target signal and the periodic component stored in the memory can be determined according to the movement distance, and thereby suppression of deviation of the compensation target signal can be enhanced.

Further, according to the optical disc control device defined in Claim 3 of the present invention, when performing jumping, retry, or seek, the move amount of the pickup in the radial direction on the optical disc is calculated based on the disc position information outputted from the disc position detector, and the gain value of the gain element is varied according to the move amount in the radial direction to control the degree of learning, and thereby focus control and tracking control can be stably carried out.

Further, according to the optical disc control device defined in Claim 4 of the present invention, since the zone memory which stores data in plural zones into which the disc is divided is used, it is possible to use the signal information in the zone where the pickup is positioned after it has been moved during jumping, retry, or seek. Therefore, a difference in period of the signal information which occurs when the movement distance of the pickup is long such as when performing long seek can be reduced, and thereby focus control or tracking control can be stably carried out immediately after the pull-in. Further, since a periodic component having the smallest difference from the periodic component obtained after seek is selected among the periodic components stored in the zone memory and the periodic component stored in the memory, highly-precise control can be carried out.

Further, according to the optical disc control device defined in Claim 5 of the present invention, since the movement completed state is estimated from the signal indicating a change in the signal period of the compensation target signal when performing jumping, retry, or seek, the position detection on the optical disc can be carried out without waiting for completion of the movement, and thereby higher-speed memory control can be carried out.

Further, according to the optical disc control device defined in Claim 6 of the present invention, when performing jumping, retry, or seek, the move amount of the pickup in the radial direction on the optical disc is calculated from the disc position information outputted from the disc position detector, the correlation between the compensation target signal and the periodic component stored in the memory is determined based on the move amount in the radial direction, and the gain value of the gain element possessed by the feedback signal system is varied to control the degree of learning, and further, the zone memory which stores data in plural zones into which the disc is divided is used to reduce the difference in period of the signal information which occurs when the movement distance is long such as when performing long seek. Therefore, highly-precise and stable focus control and tracking control can be performed.

Further, according to the optical disc control device defined in Claim 7 of the present invention, when performing jumping, retry, or seek, the move amount of the pickup in the radial direction on the optical disc is calculated from the disc position information outputted from the disc position detector, the correlation between the compensation target signal and the periodic component stored in the memory is determined based on the move amount in the radial direction, and the gain value of the gain element possessed by the feedback signal system is varied to control the degree of learning, and further, the movement completed state is estimated from the signal indicating a change in the signal period of the compensation target signal. Therefore, highly-precise and stable focus control and tracking control can be performed at high speed.

Further, according to the optical disc control device defined in Claim 8 of the present invention, the zone memory which stores data in plural zones into which the disc is divided is used to reduce a difference in period of the signal information which occurs when the movement distance is long such as when performing long seek, and the movement completed state is estimated from the signal which indicates a change in the signal period of the compensation target signal. Therefore, highly-precise and stable focus control and tracking control can be performed at high speed.

### BRIEF DESCRIPTION OF THE DRAWINGS

FIG. 1 is a block diagram illustrating an example of configuration of an optical disc control device according to a first embodiment of the present invention.

FIG. 2 is a diagram illustrating a memory configuration and a memory control operation.

FIG. 3 is a block diagram illustrating an example of configuration of an optical disc control device according to a second embodiment of the present invention.

FIG. 4 is a block diagram illustrating an example of configuration of an optical disc control device according to a third embodiment of the present invention.

FIG. 5 is a block diagram illustrating an example of configuration of an optical disc control device according to a fourth embodiment of the present invention.

FIG. 6 is a block diagram illustrating an example of configuration of an optical disc control device according to a fifth embodiment of the present invention.

FIG. 7 is a diagram illustrating the configuration of a repetitive control circuit in a conventional optical disc device.

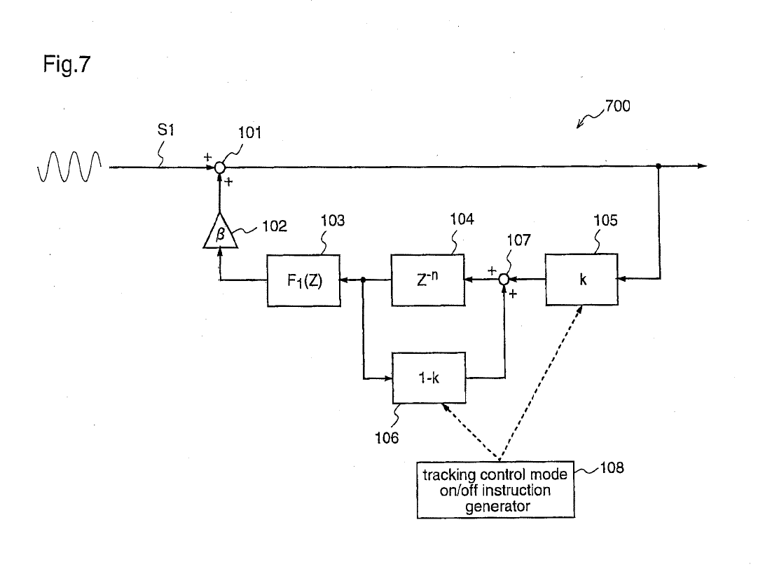

### DESCRIPTION OF REFERENCE NUMERALS

1 . . . adder
2 . . . gain clement β
3 . . . memory
4 . . . filter
5 . . . rotation speed detector
6 . . . disc position detector
7 . . . circumferential direction move amount calculator
8 . . . memory controller
9 . . . radial direction move amount calculator
10 . . . arithmetic unit
11,14 . . . switch
12 . . . comparator
13 . . . zone memory
15 . . . completion estimation unit
16,17,18,19,20 . . . feedback signal system
101 . . . first adder
102 . . . attenuation gain 3
103 . . . low-pass filter
104 . . . memory
105,106 . . . gain element
107 . . . second adder
108 . . . tracking control mode on/off instruction generator

### BEST MODES TO EXECUTE THE INVENTION

Hereinafter, best modes for executing the present invention will be described with reference to the drawings.

### Embodiment 1

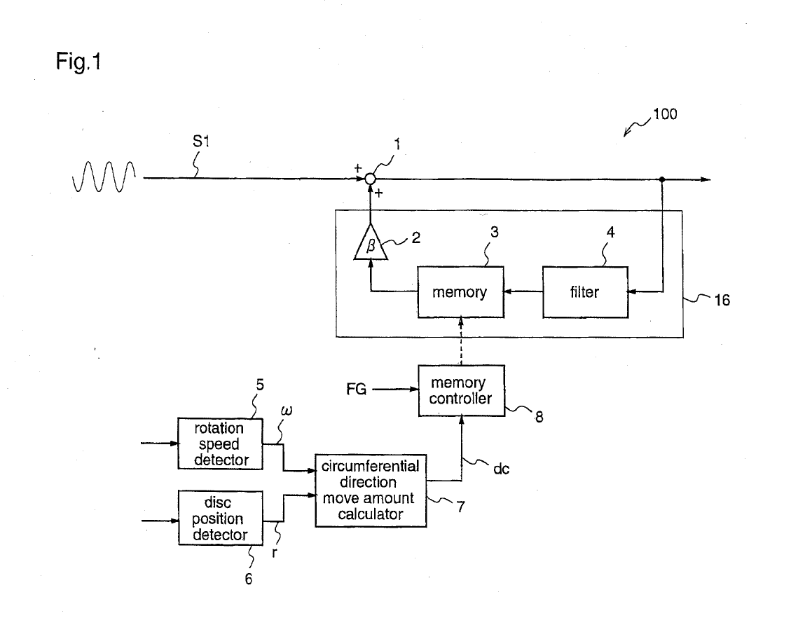

FIG. 1 is a diagram illustrating an optical disc control device (cyclic memory 100) according to a first embodiment of the present invention.

With reference to FIG. 1, reference numeral 1 denotes an adder for adding an inputted compensation target signal S1 to an output from a feedback signal system 16 described later, and reference numeral 16 denotes a feedback signal system for successively updating and storing an output signal from the adder 1 to input the same into the adder 1.

Reference numeral 2 denotes a gain element for multiplying a signal of one period that is stored in the memory 3 by a gain β (0≦β≦1) to change the degree of learning in the cyclic memory 100, and reference numeral 3 denotes a memory for storing a periodic component of one optical disc rotation.

Reference numeral 4 denotes a filter which can arbitrarily set a frequency band of a signal to be stored (learned) in the memory 3. Reference numeral 5 denotes a rotation speed detector for detecting a motor rotation speed w on the basis of motor rotation speed information of a spindle motor which rotates the optical disc, and reference numeral 6 denotes a disc position detector for detecting disc position information r which indicates the position of the pickup on the disc when performing reproduction/recording.

Reference numeral 7 denotes a circumferential direction move amount calculator which calculates a move amount dc in the circumferential direction of the disc, on the basis of the disc rotation speed w detected by the rotation speed detector 5 and the disc position information r detected by the disc position detector 6 which are obtained before starting an operation such as jumping, retry, or seek, and the disc rotation speed ω detected by the rotation speed detector 5 and the disc position information r detected by the disc position detector 6 which are obtained when the operation is completed.

Reference numeral 8 denotes a memory controller which controls the addresses in the memory 3 on the basis of the circumferential direction move amount dc calculated by the circumferential direction move amount calculator 7. In this first embodiment, the circumferential direction move amount dc is calculated based on the outputs from the rotation speed detector 5 and the disc position detector 6. However, when the memory division number is determined based on a FG signal whose period is varied according to the disc rotation speed, the circumferential direction move amount dc can be calculated by counting the FG signal during jumping, retry, or seek, and thus obtained result may be used.

Next, the operation of the optical disc control device 100 of this first embodiment will be described.

In this embodiment, for example, a focus error signal in the optical disc device will be described as a compensation target signal 51 which is an input signal. The focus error signal has a periodic component caused by surface vibration of the disc.

When a reproduction/recording operation by the optical disc device is started, the optical disc is rotated, and such as surface vibration of the disc occurs with the disc rotation. At this time, a focus error signal S1 is generated in the optical head control system. When the focus error signal S1 as a compensation target signal is input to the adder 1, an output signal of the adder 1 is input to the filter 4 which constitutes the feedback system 16. Then, the output signal of the adder 1 passes through the filter 4 having a predetermined cutoff frequency, and a signal having a frequency band for performing repetitive control is output from the filter 4.

Thereafter, the signal outputted from the filter 4 is stored in the memory 3 as signal information of just-previous one disc rotation, and this stored signal is fed back to the focus error signal S1 through the gain element 2. By performing such processing, the steady-state error included in the focus error signal S1 can be sufficiently suppressed by the feedback control.

The β as the gain element 2 is a factor which satisfies 0<β≦1 based on the stability condition for the repetitive control, and makes the degree of learning not reach 100% (the oscillation condition of the system), thereby to achieve stable control in the optical disc device and enhance only the followability without increasing the control frequency band.

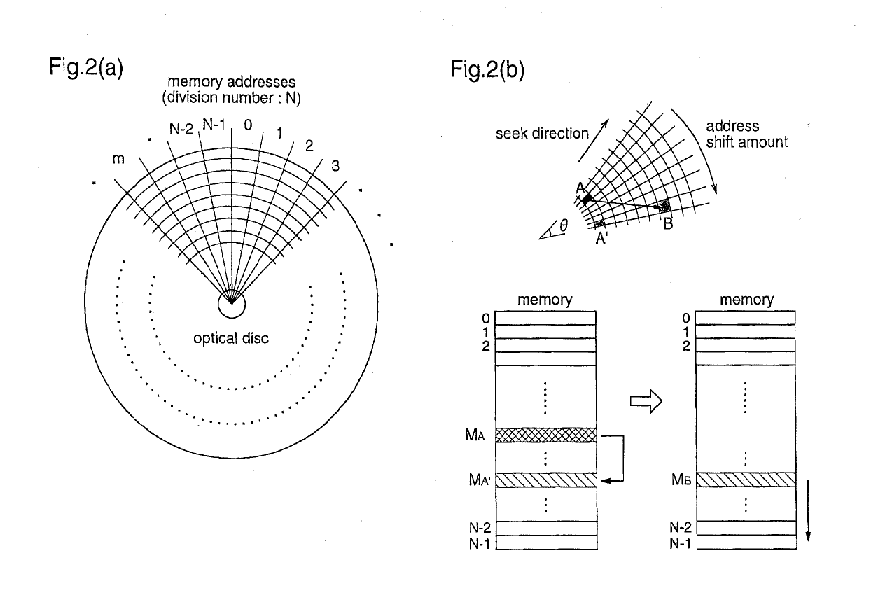

FIG. 2(a) is a diagram illustrating the relation between the position of the optical disc and the addresses in the memory 3. When the memory 3 is one for storing N pieces of information, the circumference of the disc is divided into N and signal information as a periodic component of one rotation of the disc is stored in the memory. Since the compensation target signal S1 such as the error signal in the control system of the optical disc device has a periodicity, the periodic component stored in address m in a certain period of the disc has a high correlation with the periodic component stored in address m in the next period. Thereafter, the correlation is lowered as the periods are separated from each other.

Now it is assumed that a seek operation is performed during the reproduction/recording operation. The memory control at this time will be specifically described with reference to FIG. 2(b).

FIG. 2(b) is a diagram illustrating an example of position shift on the disc when seek is performed from point A to point B on the disc. When seek is performed from point A to point B, i.e., toward the outer circumference of the disc, since the disc is rotating while the pickup is moving in the radial direction, the focus position on the disc shifts also in the circumferential direction.

Although the periodic component of one period immediately before the seek is stored in the memory 3, the inside of the memory is cleared immediately before the seek and no learning is performed for one period after the seek in the conventional method, and therefore, learning cannot be performed until the periodic component of one period is stored in the memory. Accordingly, while the periodic component of one period is being stored, an unstable element such as surface vibration cannot be suppressed.

Further, since learning by the cyclic memory is not performed during the seek even if the memory is not cleared and the readout position in the memory is not changed, a large difference occurs between the signal information in the memory after the seek and the compensation target signal being detected from the optical pickup. At this time, if the above-mentioned repetitive control is performed to the input focus error signal S1, the focus error signal S1 might perform unnecessary learning to be rather unstable.

So, in this first embodiment, memory control is performed based on the disc rotation information after the seek operation, thereby to perform learning control effectively utilizing the periodicity of the compensation target signal.

To be specific, the rotation speed detector 5 detects the motor rotation speed ω_{A} at point A on the basis of the rotation speed information of the spindle motor which rotates the optical disc, and outputs the detection result ω_{A} to the circumferential direction move amount calculator 7. Further, the disc position detector 6 detects the disc position information r_{A} from such as the address information of the disc, and outputs the detection result r_{A} to the circumferential direction move amount calculator 7.

Immediately after the seek is landed at point B, the rotation speed detector 5 detects the motor rotation speed ω_{B} and outputs the detection result ω_{B} to the circumferential direction move amount calculator 7 in the same manner as performed at point A. Further, the disc position detector 6 detects the disc position information r_{B} and outputs the detection result r_{B} to the circumferential direction move amount calculator 7.

The circumferential direction move amount calculator 7 immediately calculates a move amount dc in the circumferential direction of the disc on the basis of the disc rotation speeds ω_{A} and ω_{B} which are detected by the rotation speed detector 5 and the disc position information r_{A} and r_{B} which are detected by the disc position detector 6, and outputs the circumferential direction move amount dc to the memory controller 8.

The memory controller 8 changes the readout/write position in the memory 3 from M_{A} to M_{A′} on the basis of the circumferential direction move amount dc which is outputted from the circumferential direction move amount calculator 7. Thereby, the feedback system 16 performs learning according to the periodic component at point A′ which is correlated with point B, and thus stable focus control which can sufficiently suppress the steady-state deviation can be carried out.

While in this first embodiment adopted as the compensation target signal. S1 is a focus error signal, the present invention is not restricted thereto. For example, even when a focus driving signal is adopted as a compensation target signal, the steady-state deviation can be approximated to 0, and the deviation suppressing effect can be obtained.

Further, when performing tracking control having an eccentricity of the optical disc as a target to be followed, stable tracking control can be performed by similarly approximating the steady-state deviation to 0 using a tracking error signal as a compensation target signal to enhance the followability of the compensation target signal.

As described above, according to the optical disc control device of this first embodiment, when a large difference occurs between the signal of just-previous one period and the signal being currently detected due to a movement of the pickup position on the disc, which occurs when performing jumping, retry, or seek in the optical disc device, the readout/write position in the memory 3 is controlled by the memory controller 8 on the basis of the detection result obtained by the circumferential direction move amount calculator 7. Therefore, the followability of the compensation target signal can be enhanced by suppressing a signal deviation which is caused by such as surface vibration or eccentricity in the optical disc control device, and consequently, focus control and tracking control can be performed with constant stability in the optical disc device.

### Embodiment 2

An optical disc control device of a second embodiment is configured such that, in the optical disc control device of the first embodiment, the periodic component stored in the memory is converted into the periodic component at the landing point on the basis of a change in the rotation number of the disc before and after movement of the pickup, and thereby a difference in period of the signal information which occurs when the movement distance of the pickup is long is corrected to realize appropriate repetitive control.

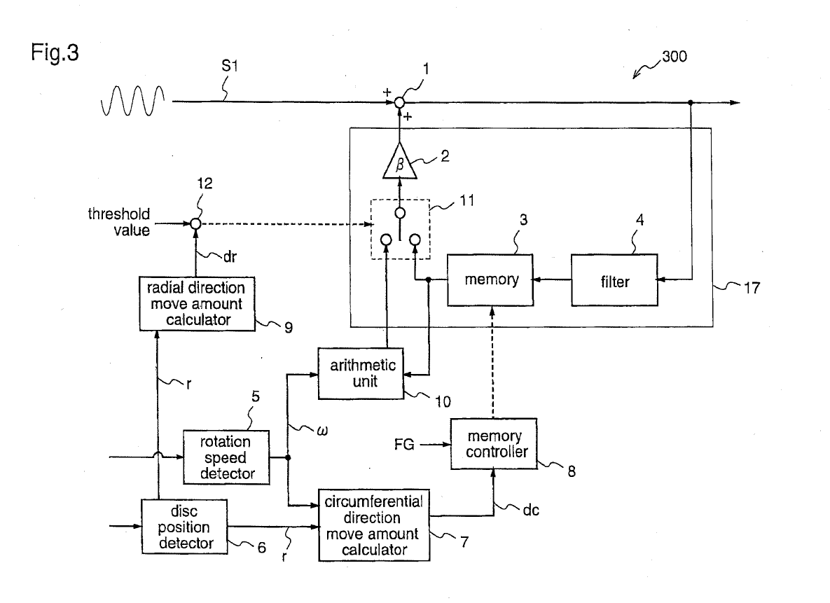

FIG. 3 is a diagram illustrating an optical disc control device (cyclic memory) 300 according to the second embodiment of the present invention. In FIG. 3, reference numeral 9 denotes a radial direction move amount calculator which calculates a move amount dr of the pickup in the radial direction on the disc on the basis of the disc position information detected by the disc position detector 6.

Reference numeral 10 denotes an arithmetic unit which converts the signal period of a feedback signal on the basis of the disc rotation speed w detected by the rotation speed detector 5 and the signal information stored in the memory 3. For example, in the case where the disc rotation control is CAV control, when seek is performed from the present recording/reproduction position toward the outer circumference, the periodic component at the landing point becomes later than the periodic component which was stored before the movement. Conversely, when seek is performed toward the inner circumference, the periodic component at the landing point becomes faster than the periodic component stored before the movement. Since a difference thus occurs in the periodic components before and after the movement of the pickup position, the arithmetic unit 10 estimates the periodic component at the landing point after the movement on the basis of a change in the disc rotation speed, and converts the stored periodic component to the periodic component at the landing point. While in this second embodiment the CAV control is adopted as an example of disc rotation control, the present invention is not restricted thereto, and CLV control or the like may be similarly executed.

Reference numeral 11 denotes a switch which selects, as a feedback signal, either of the output from the arithmetic unit 10 or the output from the memory 3, and outputs the selected signal. Reference numeral 12 denotes a comparator which compares the radial direction move amount dr calculated by the radial direction move amount calculator 9 with an arbitrary threshold value, and controls the signal output of the switch 11 on the basis of the comparison result. Since other constituents are identical to those of the first embodiment, repeated description is not necessary. Further, switching by the switch 11 may be fixed using an arbitrary signal, generation means, or it may be automatically carried out. The control method thereof is not particularly restricted.

Next, the operation of the optical disc control device 300 of this second embodiment will be described.

In this embodiment, for example, a focus error signal in the optical disc device will be described as a compensation target signal S1 which is an input signal. The focus error signal has a periodic component caused by surface vibration of the disc.

When a reproduction/recording operation by the optical disc device is started, the optical disc is rotated, and such as surface vibration of the disc occurs with the disc rotation. At this time, a focus error signal S1 is generated in the optical head control system. When the focus error signal S1 as a compensation target signal is input to the adder 1, an output signal of the adder 1 is input to the filter 4 which constitutes the feedback system 17. Then, the output signal of the adder 1 passes through the filter 4 having a predetermined cutoff frequency, whereby a signal having a frequency band for performing repetitive control is output from the filter 4.

Thereafter, the signal outputted from the filter 4 is stored in the memory 3 as signal information of just-previous one rotation of the disc, and this stored signal is fed back to the focus error signal S1 through the gain element 2. By performing such processing, the steady-state error included in the focus error signal S1 can be sufficiently suppressed by the feedback control.

The β as the gain element 2 is a factor which satisfies 0<β≦1 based on the stability condition for the repetitive control, and makes the degree of learning not reach 100% (the oscillation condition of the system), thereby to achieve stable control in the optical disc device and enhance only the followability without increasing the control frequency band.

The operations of the rotation speed detector 5, the disc position detector 6, the circumferential direction move amount calculator 7, and the memory controller 8 are identical to those described for the first embodiment.

It is now assumed that a long seek operation is performed during the reproduction/recording operation. Although the periodic component of one period just before the seek is stored in the memory 3, since the seek distance is long in the long seek, the correlation of signals before and after the seek is lowered. Accordingly, a large difference occurs between the signal information stored in the memory after the seek and the compensation target signal being detected from the optical pickup. At this time, if the above-mentioned repetitive control is performed to the inputted focus error signal S1, the focus error signal S1 might perform unnecessary learning to become rather unstable.

So, in this second embodiment, the signal period of the periodic component stored in the memory 3 is converted by the arithmetic unit 10 according to the disc rotation information obtained before and after the long seek operation, and either of the signal from the arithmetic unit 10 or the signal from the memory 3 is selected as a feedback signal according to the move amount in the radial direction.

To be specific, the radial direction move amount calculator 9 calculates the move amount dr in the radial direction of the disc on the basis of the disc position information r detected by the disc position detector 6, and outputs the calculated move amount dr to the comparator 12. The comparator 12 compares the move amount dr with a predetermined threshold value. When the move amount dr is equal to or larger than the threshold value, the comparator 12 judges that the correlation of the periodic components obtained before and after the pickup movement is low, and makes the switch 11 select the output of the arithmetic unit 10 as a feedback signal and output the same. Thereby, a signal having high correlation, whose periodicity in the circumference direction of the disc is corrected by the memory controller 8 and whose periodic component is converted by the arithmetic unit 10 according to the move amount in the radial direction, is fed back to the compensation target signal S1 to be inputted after the long seek.

Further, when the move amount dr of the pickup in the radial direction on the disc is less than the predetermined threshold value, the comparator 12 judges that the correlation of the periodic components obtained before and after the pickup movement is high, and makes the switch 11 select the signal stared in the memory 3 as a feedback signal and output the same. Thereby, a signal whose periodicity in the circumference direction of the disc is corrected by the memory controller 8 is fed back to the compensation target signal S1 to be inputted after the long seek.

As described above, according to the optical disc control device of this second embodiment, the periodic component stored in the memory is converted into the periodic component at the landing point, of the pickup on the basis of a change in the disc rotation speed at the landing point, which is caused by the movement of the pickup position. Therefore, a signal which is most correlated with the compensation target signal that is being detected by the pickup can be fed back when performing jumping, retry, or seek, and thereby the signal deviation due to such as surface vibration or eccentricity, can be further suppressed to enhance the followability of the compensation target signal, and consequently, focus control and tracking control can be performed with constant stability in the optical disc device.

### Embodiment 3

An optical disc control device according to a third embodiment of the present invention is configured such that, in the optical disc control device of the first embodiment, the value of the gain to be multiplied in the gain element is varied according to the movement distance of the pickup, thereby to perform appropriate repetitive control according to the movement of the pickup in the radial direction.

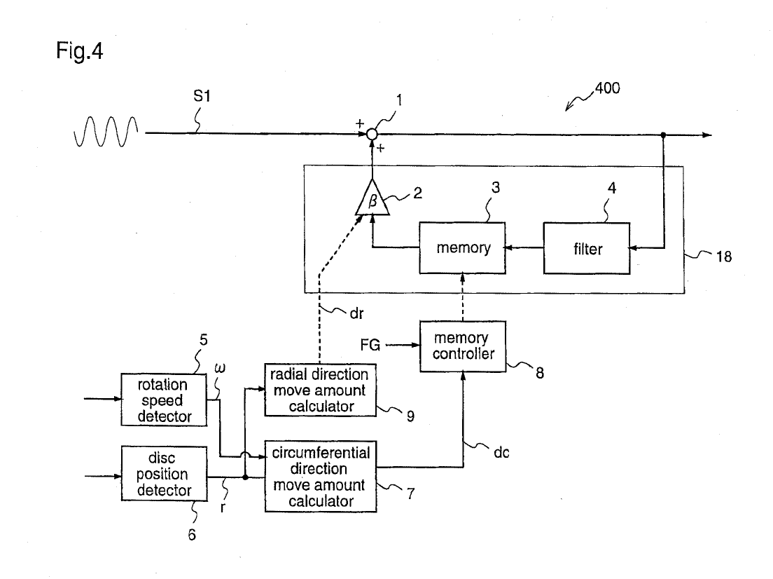

FIG. 4 is a diagram illustrating an optical disc control device (cyclic memory) 400 of this third embodiment. In FIG. 4, reference numeral 9 denotes a radial direction move amount calculator for calculating a move amount dr of the pickup in the radial direction on the disc on the basis of the disc position information r detected by the disc position detector 6. The gain element 2 which varies the degree of learning in the cyclic memory 400 is controlled according to the calculation result of the radial direction move amount calculator 9. Since other constituents are identical to those described for the first embodiment, repeated description is not necessary.

Next, the operation of the optical disc control device of this third embodiment will be described.

In this embodiment, for example, a focus error signal in the optical disc device will be described as a compensation target signal which is an input signal. The focus error signal has a periodic component caused by surface vibration of the disc.

When a reproduction/recording operation by the optical disc device is started, the optical disc is rotated, and such as surface vibration of the disc occurs with the disc rotation. At this time, a focus error signal S1 is generated in the optical head control system. When the focus error signal S1 as a compensation target signal is input to the adder 1, an output signal of the adder 1 is input to the filter 4 which constitutes the feedback system 18. Then, the output signal of the adder 1 passes through the filter 4 having a predetermined cutoff frequency, whereby a signal having a frequency band for performing repetitive control is output from the filter 4.

Thereafter, the signal outputted from the filter 4 is stored in the memory 3 as signal information of just-previous one rotation of the disc, and this stored signal is fed back, to the focus error signal S1 through the gain element 2. By performing such processing, the steady-state error included in the focus error signal S1 can be sufficiently suppressed by the feedback control.

The β as the gain element 2 is a factor which satisfies 0<β≦1 based on the stability condition for the repetitive control, and makes the degree of learning not reach 100% (the oscillation condition of the system), thereby to achieve stable control in the optical disc device and enhance only the followability without increasing the control frequency band.

Since the operations of the rotation speed detector 5, the disc position detector 6, the circumferential direction move amount calculator 7, and the memory controller 8 are identical to those described for the first embodiment, repeated description is not necessary.

It is now assumed that a seek operation is performed during the reproduction/recording operation. In this third embodiment, the value of gain β of the gain element 2 is varied at this time according to the movement distance of the pickup on the disc.

To be specific, before and after the seek operation, the radial direction move amount calculator 9 calculates a move amount dr of the pickup in the radial direction on the basis of the disc position information r detected by the disc position detector 5. Since the correlation between the signal information stored in the memory and the compensation target signal being detected from the optical pickup is high when the radial direction move amount dr calculated is relatively small, the radial direction move amount calculator 9 changes the value of gain β of the gain element 2 so as to make it approach to 1. Conversely, when the radial direction move amount dr is relatively large, the calculator 9 changes the value of gain β of the gain element 2 so as to make it approach to 0.

Thereby, since the signal information in which the degree of learning is changed according to the movement distance of the pickup on the optical disc can be added to the compensation target signal, the operation of the feedback signal system 17 can be performed stably and reliably.

While in this third embodiment the radial direction move amount dr is calculated by the radial direction move amount calculator 9 on the basis of the disc position information r which is obtained before and after the seek, the present invention is not restricted thereto. For example, the number of track crosses is detected using a track cross signal, the seek distance is calculated based on the detection result, and the value of gain β of the gain element 2 may be changed according to the calculated seek distance.

As described above, according to the optical disc control device of this third embodiment, when performing jumping, retry, or seek, the readout/write position in the memory 3 is controlled by the memory controller 8 on the basis of the result obtained by the circumferential direction move mount calculator 7, and the movement distance of the pickup in the radial direction on the disc is calculated by the radial direction move amount calculator 9 and the value of gain β of the gain element 2 is varied according to the calculation result to vary the degree of learning in the cyclic memory. Therefore, the periodic component can be corrected according to the move amount of the pickup in the radial in addition to the move amount in the circumferential direction, and thereby focus control and tracking control can be performed with constant stability in the optical disc device.

### Embodiment 4

According to a fourth embodiment of the present invention, in the optical disc control device of the first embodiment, a plurality of memories sorted according to the positions on the optical disc are provided, and appropriate repetitive control is performed using signal information stored in a memory corresponding to the position of the pickup on the optical disc.

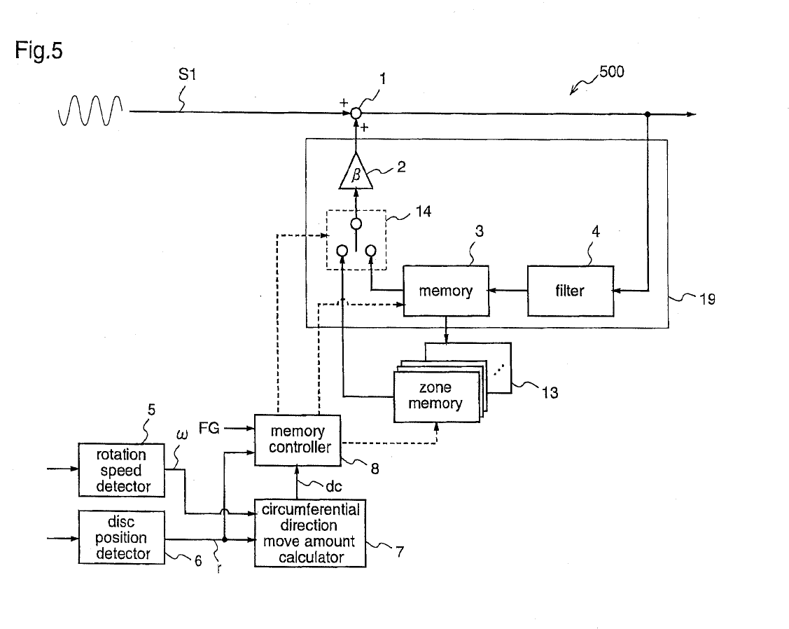

FIG. 5 is a diagram illustrating an optical disc control device (cyclic memory) 500 of this fourth embodiment. In FIG. 5, reference numeral 13 denotes a zone memory comprising plural memories for storing the latest signal information corresponding to plural zones into which the optical disc is divided, respectively. Reference numeral 14 denotes a switch for selecting either of the output from the zone memory 13 or the output from the memory 3 as an output signal to the gain element 2. Further, the memory controller 8 of this fourth embodiment controls the memory 3 on the basis of the calculation result dc obtained by the circumferential direction move amount calculator 7, and controls the readout of the signal information from the zone memory 13 and the output of the switch 14 on the basis of the calculation result dc obtained by the circumferential direction move amount calculator 7 and the disc position information r detected by the disc position detector 6. Since other constituents are identical to those described for the first embodiment, repeated description is not necessary.

Next, the operation of the optical disc control device 500 of this fourth embodiment will be described.

In this embodiment, a focus error signal in the optical disc device will be described as a compensation target signal which is an input signal. The focus error signal has a periodic component caused by surface vibration of the disc.

When a reproduction/recording operation by the optical disc device is started, the optical disc is rotated, and such as surface vibration of the disc occurs with the disc rotation. At this time, a focus error signal S1 is generated in the optical head control system. When the focus error signal S1 as a compensation target signal is input to the adder 1, an output signal of the adder 1 is input to the filter 4 which constitutes the feedback system 19. Then, the output signal of the adder 1 passes through the filter 4 having a predetermined cutoff frequency, whereby a signal having a frequency band for performing repetitive control is output from the filter 4.

Thereafter, the signal outputted from the filter 4 is stored in the memory 3 as signal information of just-previous one rotation of the disc, and this stored signal is fed back to the focus error signal S1 through the gain element 2. By performing such processing, the steady-state error included in the focus error signal S1 can be sufficiently suppressed by the feedback control.

The β as the gain element 2 is a factor which satisfies 0<β≦1 based on the stability condition for the repetitive control, and makes the degree of learning not reach 100% (the oscillation condition of the system), thereby to achieve stable control in the optical disc device and enhance only the followability without increasing the control frequency band.

Since the operations of the rotation speed detector 5, the disc position detector 6, and the circumferential direction move amount calculator 7 are identical to those described for the first embodiment, repeated description is not necessary.

It is now assumed that a seek operation is performed during the reproduction/recording operation. At this time, in this fourth embodiment, the disc position detector 6 detects the disc position at the landing point after the seek. The respective memories configuring the zone memory 13 correspond to the plural zones into which the position on the disc has previously been divided, and each memory stores the latest periodic component of one period in each zone. The memory controller 8 determines as to which zone corresponds to the current position on the disc according to the disc position information r outputted from the disc position detector 6, and changes the readout/write position in the memory included in the zone memory 13, which memory corresponds to the determined zone, on the basis of the circumferential direction move amount dc calculated by the circumferential direction move amount calculator 7.

Then, the memory controller 8 controls the switch 14 to make the switch select a periodic component having the smallest difference from the periodic component after the seek among the periodic components outputted from the zone memory 13 and the periodic component outputted from the ordinary memory 3, on the basis of the circumferential direction move amount dc calculated by the circumferential direction move amount calculator 7 and the disc position information r detected by the disc position detector 6.

Thereafter, the normal feedback control is performed by the memory 3, and the signal information which is newly input to the memory 3 is input to the zone memory 13, and thus the latest signal information is always stored in the zone memory 13.

Thereby, the signal information in the zone which is closest to the position of the pickup on the disc can be added to the compensation target signal S1 according to the position of the pickup after the seek, and thus the operation of the feedback system 10 can be stably and reliably carried out.

Although the number of memories in the zone memory and the division width (the capacity of each memory) are not particularly considered, when the disc is divided into more zones, the correlation between the signal information stored in the memories and the periodic component of the compensation target signal is more increased, thereby realizing higher suppression effect and more precise learning control. For example, since a DVD-RAM disc (4.7G) has 35 zones given in the disc format, the number of memories in the zone memory 13 may be set to 35 to be assigned to the respective zones in the DVD-RAM disc. Further, when performing CAV control, since the speed is increased toward the outer circumference, more precise control is required. In this case, the control precision can be maintained by assigning more memories to the outer zones. Further, since division into finer zones provides higher effect of suppressing deviation and highly-precise learning control as described above, when this fourth embodiment is applied to a disc device for a high-density recording medium such as a blu-ray disc, more remarkable effect can be obtained.

As described above, according to the optical disc control device of this fourth embodiment, when performing jumping, retry, or seek, the position of the pickup on the disc after movement of the pickup is detected by the disc position detector 6, and the signal information stored in the zone which is closest to the present disc position is obtained from the detection result to be used for learning control. Therefore, the signal information in the zone closest to the position of the pickup on the disc can be added to the compensation target signal according to the position of the pickup after the seek, and thereby focus control and tracking control immediately after the movement of the pickup can be stably performed in the optical disc device.

### Embodiment 5

According to a fifth embodiment of the present invention, in the optical disc control device of the first embodiment, when performing jumping, retry, or seek, a circumferential direction move amount is calculated with estimating the landing point after movement of the pickup, thereby to achieve speed-up of the control operation for the optical disc device.

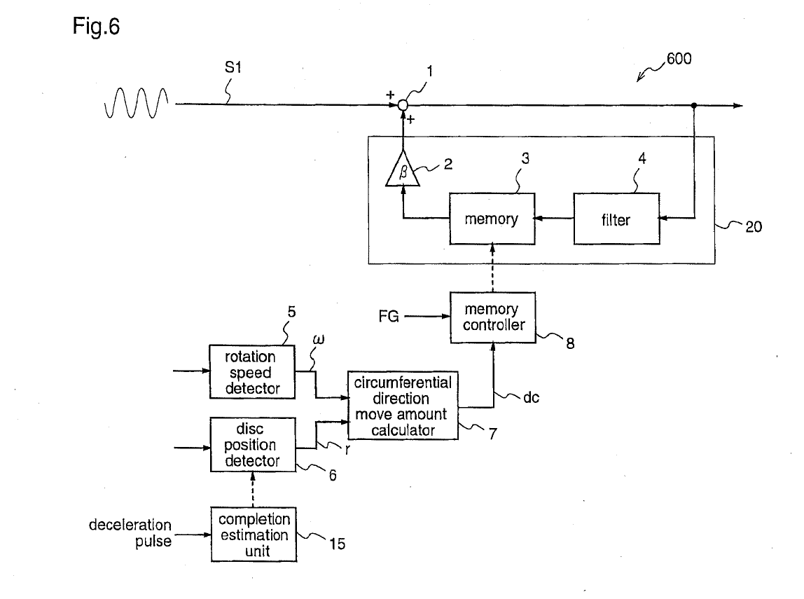

FIG. 6 is a diagram illustrating an optical disc control device (cyclic memory) 600 of this fifth embodiment.

In FIG. 6, reference numeral 15 denotes a completion estimation unit which estimates the movement completed state of the pickup according to an arbitrary signal which indicates a change in the signal period. Since other constituents are identical to those described for the first embodiment, repeated description is not necessary.

Next, the operation of the optical disc control device 600 of this fifth embodiment will be described.

In this embodiment, a focus error signal in the optical disc device will be described as a compensation target signal which is an input signal. The focus error signal has a periodic component caused by surface vibration of the disc.

When a reproduction/recording operation by the optical disc device is started, the optical disc is rotated, and such as surface vibration of the disc occurs with the disc rotation. At this time, a focus error signal S1 is generated in the optical head control system. When the focus error signal S1 as a compensation target signal is input to the adder 1, an output signal of the adder 1 is input to the filter 4 which constitutes the feedback system. Then, the output signal of the adder 1 passes through the filter 4 having a predetermined cutoff frequency, whereby a signal having a frequency band for performing repetitive control is output from the filter 4.

Thereafter, the signal outputted from the filter 4 is stored in the memory 3 as signal information of just-previous one rotation of the disc, and this stored signal is fed back to the focus error signal S1 through the gain element 2. By performing such processing, the steady-state error included in the focus error signal S1 can be sufficiently suppressed by the feedback control.

The β as the gain element 2 is a factor which satisfies 0 <β≦1 based on the stability condition for the repetitive control, and makes the degree of learning not reach 100% (the oscillation condition of the system), thereby to achieve stable control in the optical disc device and enhance only the followability without increasing the control frequency band.

Since the operations of the rotation speed detector 5, the disc position detector 6, the circumferential direction move amount calculator 7, and the memory controller 8 are identical to those described for the first embodiment, repeated description is not necessary.

Now it is assumed that a seek operation is performed during the reproduction/recording operation. At this time, in this fifth embodiment, the completion estimation unit 15 estimates the position of the pickup on the optical disc at the time of completing the seek operation by using such as a deceleration pulse immediately before the seek end, and outputs the estimation result to the disc position detector 6. The disc position detector 6 generates disc position information r on the basis of the pickup position on the disc at the landing point that is estimated by the completion estimation unit 15, and outputs the disc position information r to the circumferential direction move amount calculator 7.

Thereby, detection of the disc position can be performed faster than in the case of detecting the disc position after the seek completion, and consequently, the circumferential direction move amount dc can be calculated faster. Therefore, the operation of the feedback system 20 can be speedily and stably performed in response to speed-up of the optical disc device.

While in the above description the completion estimation unit 15 estimates the movement completed state of the pickup using the deceleration pulse immediately before the seek end, the present invention is not restricted to that using the deceleration pulse. For example, the movement completed state of the pickup may be estimated using a change in the track crossing speed which is obtained based on the tracking error signal.

Further, while the disc position detector 6 generates the disc position information r using the estimation result obtained by the completion estimation unit 15, the present invention is not restricted thereto. The rotation speed detector 5 may estimate the rotation speed at the landing point by using the estimation result of the completion estimation unit 15.

As described above, according to the optical disc control device of this fifth embodiment, when performing jumping, retry, or seek, the position of the pickup on the disc after movement of the pickup is estimated before the landing by the completion estimation unit 15, and the circumferential direction move amount dc is detected using the estimation result. Therefore, the circumferential direction move amount dc can be calculated faster, and thereby focus control and tracking control immediately after the pickup movement can be speedily and stably performed, and the operation of the feedback signal system 20 can be speedily and stably performed in response to speed-up of the optical disc device.

The optical disc control device of the present invention is not restricted to the above-described embodiments, and the configurations of the optical disc control devices of the first to fifth embodiments may be arbitrarily combined. For example, the zone memory 13 and the switch 14 described in the fourth embodiment may be provided in the third embodiment. Alternatively, the completion estimation unit 15 of the fifth embodiment may be provided in the second to fourth embodiments.

### APPLICABILITY IN INDUSTRY

An optical disc control device of the present invention is useful in that it has a repetitive control system and can enhance the stability and followability of focus/tracking control in an optical disc device. Further, it can be also applied to purposes for increasing the speed and densification of the optical disc device.

1. An optical disc control device which performs a learning control for compensating a compensation target signal having a periodic frequency component corresponding to one rotation of an optical disc by using signal information of one period of the optical disc, and performs a servo control of a laser beam by using the compensated signal, comprising:
an adder which receives the compensation target signal having a periodic frequency component, which is read out from the optical disc;
a filter which outputs a signal component included in a predetermined learning frequency band in the output signal of the adder;
a memory which successively updates the output signal of the filter, and stores the signal information of one period of the optical disc into addresses of one cycle;
a gain element which multiplies the signal information outputted from the memory by a gain which is not less than 0 and not larger than 1, and inputs the product to the adder;
a rotation speed detector which detects the rotation speed of the optical disc;
a disc position detector which detects the position of the pickup on the optical disc, and outputs the detection result as disc position information;
a circumferential direction move amount calculator which calculates the move amount of the pickup in the circumferential direction on the optical disc on the basis of the rotation speed of the optical disc which is outputted from the rotation speed detector, and the disc position information which is outputted from the disc position detector; and
a memory controller which control the addresses for reading out the signal information stored in the memory on the basis of the circumferential direction move amount which is calculated by the circumferential direction move amount calculator.

2. An optical disc control device as defined in claim 1 including:
an arithmetic unit which converts the signal period of the signal information stored in the memory on the basis of the rotation speed of the optical disc which is detected by the rotation speed detector;
a radial direction move amount calculator which calculates the move amount of the pickup in the radial direction on the optical disc on the basis of the disc position information which is outputted from the disc position detector; and
a switch which switches an input to the gain element between the output of the arithmetic unit and the output of the memory on the basis of a comparison result obtained by comparing the move amount of the pickup in the radial direction which is calculated by the radial direction move amount calculator with a predetermined threshold value.

3. An optical disc control device as defined in claim 1 including:
a radial direction move amount calculator which calculates the move amount of the pickup in the radial direction on the optical disc on the basis of the disc position information which is outputted from the disc position detector, wherein
the value of the gain used for the multiplication by the gain element is varied based on the move amount of the pickup in the radial direction which is calculated by the radial direction move amount calculator.

4. An optical disc control device as defined in claim 1 including:
a zone memory which, with the disc being divided into plural zones, comprises plural memories each for storing the signal information of one period in each of the divided zones;
a switch which switches an input to the gain element between the output of the zone memory and the output of the memory; and
said memory controller selecting a memory from which data are to be read out among the plural memories configuring the zone memory, on the basis of the disc position information outputted from the disc position detector, controlling the address for reading out the signal information stored in the selected memory on the basis of the circumferential direction move amount calculated by the circumferential direction move amount calculator, and controlling the output of the switch on the basis of the circumferential direction move amount which is calculated by the circumferential direction move amount calculator and the disc position information which is outputted from the disc position detector.

5. An optical disc control device as defined in claim 1 including:
a completion estimation unit which estimates the movement completed state of the pickup from a predetermined signal which indicates a change in the signal period of the compensation target signal; and
said disc position detector detecting the position of the pickup on the optical disc on the basis of the result of the pickup movement completion estimation which is outputted from the completion estimation unit.

6. An optical disc control device as defined in claim 3 including:
a zone memory which, with the disc being divided into plural zones, comprises plural memories each for storing the signal information of one period in each of the divided zones;
a switch which switches an input to the gain element between the output of the zone memory and the output of the memory; and
said memory controller selecting a memory from which data are to be read out among the plural memories configuring the zone memory, on the basis of the disc position information outputted from the disc position detector, controlling the address for reading out the signal information stored in the selected memory on the basis of the circumferential direction move amount calculated by the circumferential direction move amount calculator, and controlling the output of the switch on the basis of the circumferential direction move amount which is calculated by the circumferential direction move amount calculator and the disc position information which is outputted from the disc position detector.

7. An optical disc control device as defined in claim 3 including:
a completion estimation unit which estimates the movement completed state of the pickup from a signal which indicates a change in the signal period of the compensation target signal; and
said disc position detector detecting the position of the pickup on the optical disc on the basis of the result of the pickup movement completion estimation which is outputted from the completion estimation unit.

8. An optical disc control device as defined in claim 4 including:
a completion estimation unit which estimates the movement completed state of the pickup from a signal which indicates a change in the signal period of the compensation target signal; and
said disc position detector detecting the position of the pickup on the optical disc on the basis of the result of the pickup movement completion estimation which is outputted from the completion estimation unit.
